(19) United States
(12) Patent Application Publication
(10) Pub. No.: US 2020/0270935 A1
(43) Pub. Date: Aug. 27, 2020

(54) Storm Door

(71) Applicant: Edward Mittelstadt, Carmel, NY (US)

(72) Inventor: Edward Mittelstadt, Carmel, NY (US)

(21) Appl. No.: 16/784,496

(22) Filed: Feb. 7, 2020

Related U.S. Application Data
(60) Provisional application No. 62/810,616, filed on Feb. 26, 2019.

(51) Int. Cl. E06B 5/00; E06B 3/28; E06B 7/28

(52) U.S. Cl. CPC E06B 5/003; E05Y 2900/132; E06B 7/28; E06B 3/28

(57) ABSTRACT

An improved storm door for a building. The improved storm door includes a main portion and a plurality of edge portions that includes a top edge, a latch edge, and a hinge edge. The main portion is thicker than the edges of the plurality of edge portions, and is sized to secure an insulated glass panel therein. The edge portion is thinner than the main portion, and can secure an insulated gasket thereon. The insulated glass panel and insulated gasket improve insulation of the improved storm door, and seal an interior of the building from an exterior of the building.

### CROSS REFERENCE TO RELATED APPLICATIONS

This application claims priority under 35 U.S.C. § 119(e) to U.S. Provisional Application No. 62/810,616 filed on Feb. 26, 2019. The above identified patent application is incorporated by reference herein in its entirety to provide continuity of disclosure.

### BACKGROUND OF THE INVENTION

The present invention relates to an improved storm door for insulating an interior of a building from an exterior of the building.

Ordinary storm doors are external-facing doors placed within entryways of buildings, such as houses, and often include a glass panel or a screen panel therein to enable an individual to view the exterior of the building from the interior of the building, or vice versa. They are often used in combination with a main door, which is often sturdy and provides a greater degree of insulation from the exterior of the building relative to the ordinary storm door, which does not provide much, if any, insulation. As a result, when the main door is left open and the ordinary storm door is the only barrier between the interior of the building and the exterior of the building at the entryway, there is often a substantial draft and resulting loss of warm or cool air from the interior of the building, which increases heating and cooling costs, respectively.

Therefore, there is a need in the art for an improved storm door that provides a view through the improved storm door, but which also provides a greater degree of insulation relative to an ordinary storm door. The present invention addresses this unmet need.

Articles and devices have been disclosed in the art that relate to storm doors. These include items that have been patented and published in patent application publications. These items are often unsatisfactory with respect to their ability to insulate an interior of a building from an exterior of the building. In view of the items disclosed in the art, it is submitted that there is a need for an improvement to existing storm doors. In view of the present disclosure, it is submitted that the present invention substantially diverges in structural and functional elements from items in the art, and substantially fulfills an unmet need.

### SUMMARY OF THE INVENTION

In view of the disadvantages inherent in the known types of storm door items in the art, the present invention provides a new and improved storm door, wherein the same can be utilized for providing an individual with a view therethrough while also effectively insulating an interior of a building from an exterior of the building.

It is therefore an object of the present invention to provide an improved storm door for effectively insulating an interior of a building from an exterior of the building.

In one aspect, the invention provides a storm door, comprising a main portion and a plurality of edge portions, wherein the plurality of edge portions comprises a top edge, a latch edge, and a hinge edge. The main portion is configured to secure one or more insulated glass panels therein, and each edge portion of the plurality of edge portions comprises a recess in an interior-facing side of the storm door. In various embodiments, the recesses are each configured to receive an insulated gasket therein. In this manner, the one or more glass panels, optionally combined with one or more insulated gaskets, provides an improved insulation of an interior of a building to which the storm door is installed. The storm door may be installed such that it opens outward from the interior of the building to an exterior of the building. In such an installation, when wind blows against the storm door, it increases a pressure between the storm door and an adjacent structure a doorway containing the storm door, and in this manner the storm door does not blow open, and a seal between the interior of the building and the exterior of the building is strengthened or maintained.

In some embodiments, the plurality of edge portions does not include a bottom edge of the storm door. The bottom edge of the storm door may be excluded from having the recess thereon, and in this manner, the bottom edge of the storm door may be configured to include a sweep installed thereto for increased insulation. In this manner, the sweep, the one or more insulated glass panels, and the one or more insulated gaskets together may provide an even greater degree of insulation.

In some embodiments, a thickness of the storm door is greater than a thickness of an ordinary storm door. The greater thickness of the storm door enables installation of a thicker glass into the storm door, which may be insulated for greater energy conservation and more effective heating and cooling of the interior of the building. The thicker glass may include a thickness of ½ inch, or about ½ inch, and may be an insulated glass manufactured for improved insulation. In various embodiments, in order to accompany the one or more insulated glass panels, the thickness of the storm door is 1½ inches, or about 1½ inches, and may be comprised of a sturdy material, including but not limited to wood. In various embodiments, a particular wood chosen for manufacturing the storm door does not bend or warp upon exposure to the elements, and is sufficiently durable and sturdy so as to hold the one or more insulated glass panels therein and improve insulation.

In some embodiments, the main portion is configured to secure one or more screen panels therein, and the one or more insulated glass panels may be replaced by the one or more screen panels. The screen panels may include brass screens that are weather resistant, and in this manner, the screen panels may be utilized in humid or salty and humid environments, such as may be found near an ocean. In this manner, in warmer seasons or climates, the storm door may be configured for use to allow a breeze therethrough via the one or more screen panels. In such embodiments, the door is suitable for use in harsh or salty environments and does not warp, degrade, or deteriorate in such environments.

In some embodiments, the recesses are each a rabbet. A rabbet may include, but is not necessarily limited to, a recess cut into a corner edge of a piece of material such that the recess cut may include a ninety degree (90°) angle. Generally, the rabbet is an element of the present invention that is used for allowing use of a thicker storm door while also matching with a trim on an exterior surface of the building, and also allowing the insulated gasket to be installed thereto. In some embodiments, the rabbet may have sides that are equal in length to form a squared rabbet. In various embodiments, the rabbet is configured to hold and secure the insulated gasket therein. In various embodiments, this may be accomplished by the addition of a weather stripping groove within the rabbet. After producing the weather stripping groove within the rabbet, the insulated gasket may be installed into the weather stripping groove with a portion protruding therefrom for sealing the interior of the building from the exterior of the building upon closing the storm door, as described elsewhere herein.

In some embodiments, the storm door further comprises a flush-mount rim lock installed thereto. Because storm doors are often target for break-ins, the security of storm doors is often a concern for many individuals. In such circumstances, a rim lock, such as the flush-mount rim lock, may be utilized in making a particular embodiment for improved security. In this manner, thieves and burglars may experience greater difficulty breaking into the building with the rim lock or the flush-mount rim lock installed onto the storm door.

In some embodiments, the storm door is sized for use with a standard doorway of a building. One objective of the present invention is to enable retrofitting of existing doorways with the storm door of the present invention, as well as provide the storm door of the present invention for use and inclusion in new construction of buildings, such as houses. To achieve this, the storm door of the present invention may be sized and configured for use with the standard doorway, which may be three feet (3′) in width, and six feet eight inches (6′8″) in height. Accordingly, in some embodiments, a width of the storm door is equal to 3 feet or about 3 feet, and a height of the storm door is equal to 6 feet 8 inches or about 6 feet 8 inches.

Another object of the present invention is to provide a storm door that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a front perspective view of an exemplary storm door according to the present invention, as viewed from an interior of a building.

FIG. 2 depicts a horizontal cross section of the exemplary storm door.

FIG. 3 depicts a vertical cross section of the exemplary storm door.

FIG. 4A depicts a close-up horizontal cross section of the exemplary storm door in an open configuration.

FIG. 4B depicts a close-up horizontal cross section of the exemplary storm door in a closed configuration.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

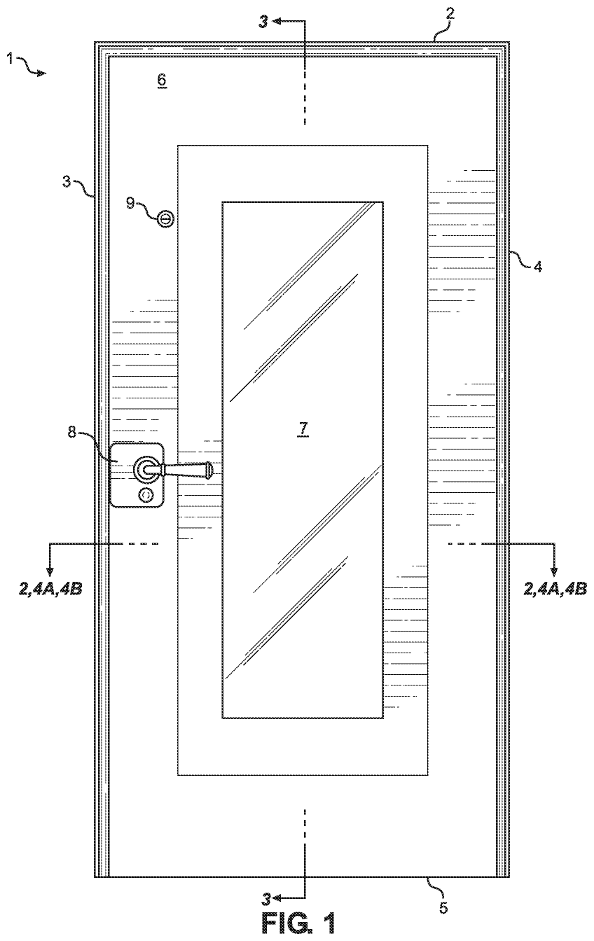

Referring now to FIG. 1, there is depicted a front perspective view of an exemplary storm door according to the present invention, as viewed from an interior of a building. A storm door 1 includes a plurality of edge portions, including a top edge 2, a latch edge 3, a hinge edge 4, and a bottom edge 5. A main portion 6 of the storm door 1 secures one or more insulated glass panels 7 therein, and some edge portions (e.g., the top edge 2, the latch edge 3, and the hinge edge 4) comprise a recess in an interior-facing side of the storm door, as described elsewhere herein. The recesses are configured to receive an insulated gasket therein, and in this manner, the one or more insulated glass panels 7, in combination with the insulated gaskets, provides an improved insulation of an interior of a building to which the storm door is installed.

In the shown embodiment, a latch 8 is positioned adjacent to the latch edge 3, and is configured to enable an individual to open and close the storm door as needed. In some embodiments, the latch 8 may include a rim lock, such as a flush-mount rim lock, operably installed thereto. In this manner, the security of the storm door may be improved. In addition, in the shown embodiment, one or more fasteners 9 may be used to secure the one or more insulated glass panels 7 to the main portion 6. The one or more fasteners 9 may be removed to dislodge the one or more insulated glass panels 7 from the main portion, and to secure one or more screen panels to the main portion 6. In this manner, the storm door 1 may be configured for use in any season or climate according to need.

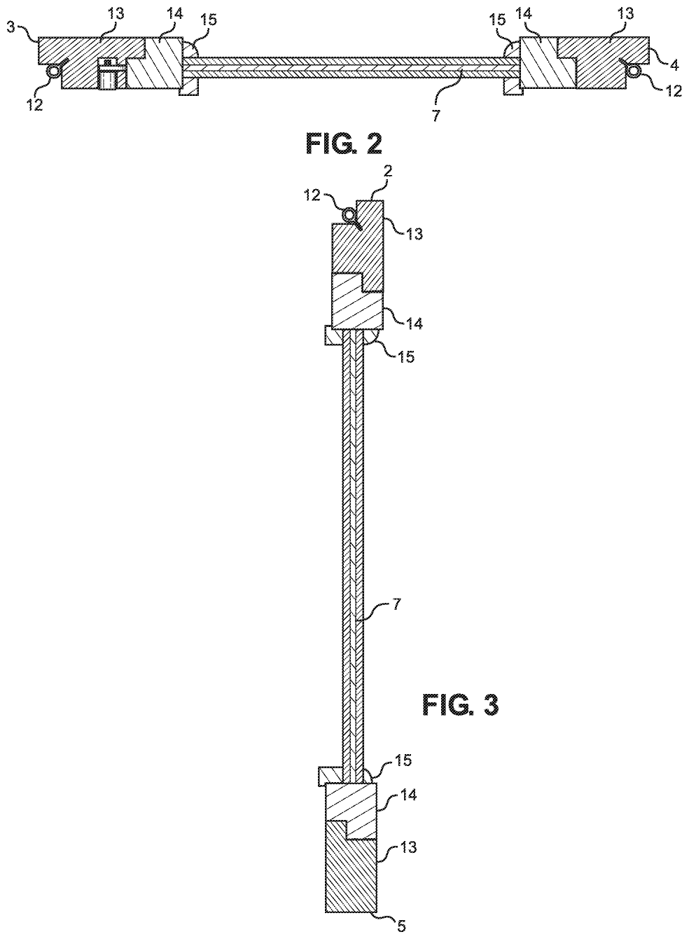

Referring now to FIG. 2, there is depicted a horizontal cross section of the exemplary storm door. The latch edge 3 and the hinge edge 4 each includes a recess on an interior-facing portion thereof, and the recesses are each shown with an insulated gasket 12 installed thereto. The insulated gasket 12 includes an elongated strip portion that is inserted into a weather stripping groove during installation, leaving a protruding portion that is cylindrical in shape when no force is applied thereto. In this manner, the latch edge 3 and the hinge edge 4 are each effectively insulated and air is prevented or hindered from moving through a crack between either the latch edge 3 and an adjacent structure of the hinge edge 4 and an adjacent structure when the storm door is in a closed configuration.

In the shown embodiment, the recesses of the latch edge 3 and the hinge edge 4 are each rabbets. In the shown embodiment, the rabbits comprising the recesses of these portions may have sides that are equal in length to form a squared rabbet. Generally, a rabbet may be a cut made at an edge of a material which, if made at a middle portion of the material, may be a dado or a groove. The rabbet cut may be made according to any suitable method, whether facilitated by a cutting machine or performed manually with one or more hand tools, according to necessity, knowledge, and ability of a particular individual making the storm door of the present invention.

In the shown embodiment, the one or more insulated glass panels 7 may be comprised of a safety glass. The safety glass may be more difficult to break through, thereby increasing the security of the storm door. In addition, the safety glass may include a film of plastic at a middle or inner portion thereof, and in this manner, when the safety glass does break, it does not produce large or dangerous shards of glass that may cause injury or damage to persons or structures.

In the shown embodiment, the one or more glass panels 7 may be secured in place by a stop 15, which is secured to an insert 14. The insert 14 is in turn secured to a stile 13. The one or more glass panels 7 may be removed from the main portion of the door by removing the one or more fasteners from the main portion, which loosens the one or more glass panels 7 within the main portion. This may be useful for replacing the one or more glass panels 7 with one or more alternate glass panels, or with one or more screen panels, such as brass panels, according to need.

Referring now to FIG. 3, there is depicted a vertical cross section of the exemplary storm door. In the shown embodiment, the interior of the building is a left direction of the figure, in a direction of the insulated gasket 12 of the top edge 2 of the storm door. In the shown embodiment, the one or more glass panels 7 may be secured in place by the stop 15, which is secured to the insert 14. The insert 14 is in turn secured to the stile 13.

In the shown embodiment, the bottom edge 5 of the storm door does not comprise a recess thereon, and in this manner, the bottom edge 5 may be configured to enable the storm door to open and close without use of an insulated gasket therein. In such embodiments, the bottom edge 5 may be outfitted with a sweep (not shown), so as to improve insulation of the storm door when in the closed configuration. In such embodiments, the sweep, combined with the one or more insulated glass panels 7 and the insulated gaskets 12, may provide a highly effective seal that prevents winds from entering the interior of the building through an entryway with the storm door installed thereto.

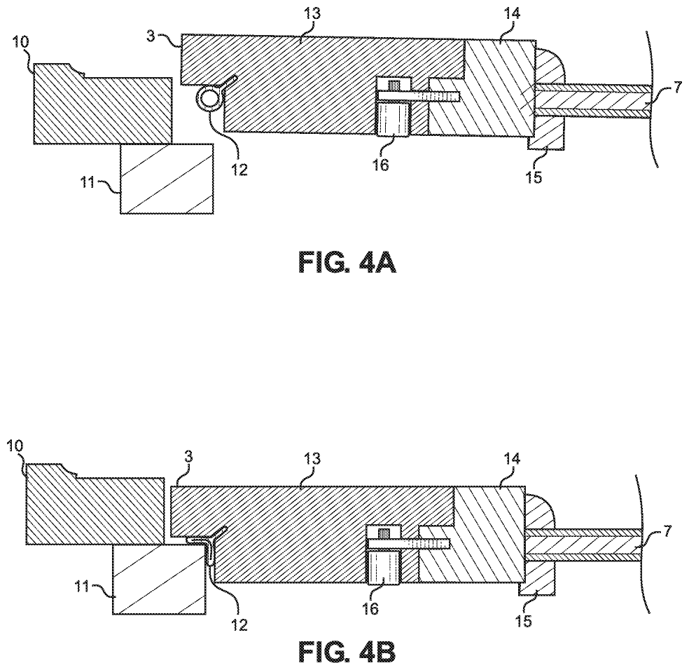

Referring now to FIGS. 4A and 4B, there are depicted a close-up horizontal cross section of the exemplary storm door in an open configuration (FIG. 4A) and in a closed configuration (FIG. 4B). In the open configuration, a gap is created between the latch edge 3 and one or more adjacent structures, which in the shown embodiment includes a moulding (e.g., a brick moulding 10) and a doorjamb 11. The moulding 10 is exterior facing, and the doorjamb 11 is interior facing. The stile 13 includes the latch edge 3 on a left portion thereof, which includes the recess having the insulated gasket 12 therein. In the shown embodiment, the recess is a rabbet, as described elsewhere herein. The rabbet is complementary to the doorjamb 11, and in the closed configuration (see FIG. 4B), the rabbet rests flush or nearly flush with the door jamb 11, and the stile 13 rests flush or nearly flush with the moulding 10. In the shown embodiment, the storm door includes an insert catch 16, which is used to secure the stile 13 to the insert 14. The insert 14 in turn includes the stop 15 attached thereto, which holds the one or more insulated glass panels 7 therein.

In the open configuration (FIG. 4A), the insulated gasket 12 includes a cylindrical shape (circular cross section), and in the closed configuration (FIG. 4B), the insulated gasket 12 includes a flattened shape. The insulated gasket is generally comprised of a flexible material that may also be waterproof and/or weatherproof. In this manner, moisture or humidity does not pass through the gap when the door is in the closed configuration.

The present invention provides a storm door that is improved relative to ordinary storm doors. The storm door includes a portion that extends further, interiorly, into the interior of the building, beyond an outer edge of the doorjamb 11. In this manner, the storm door is configured to include a thickness that is greater than a thickness of an ordinary storm door. The greater thickness enables installation of one or more insulated glass panels 7 therein, as these insulated glass panels 7 are thicker than ordinary glass and require accommodation in the surrounding structure for them to fit therein.

Various techniques may be incorporated in a method of making the improved storm door of the present invention. These include, but are not necessarily limited to, a mortise and tenon technique for joining two or more components, such as the stile 13 and the insert 14, and/or the insert 14 and the stop 15. In some embodiments, a cope and stick technique may be used for the inserts 14, and half lap joints may be made for a frame of the storm door. In various embodiments, as presented herein and as would be understood based on the present disclosure, a rabbeted frame perimeter is included in the design, and the rabbeted frame perimeter may be limited to the top edge, the latch edge 3, and the hinge edge, and may not extend to the bottom edge, as described elsewhere herein.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A storm door, comprising:
a main portion and a plurality of edge portions, wherein the plurality of edge portions comprises a top edge, a latch edge, and a hinge edge;
wherein the main portion is configured to secure one or more insulated glass panels therein;
wherein each edge portion of the plurality of edge portions comprises a recess in an interior-facing side of the storm door, wherein the recesses are each configured to receive an insulated gasket therein.

2) The storm door of claim 1, wherein the plurality of edge portions does not include a bottom edge of the storm door.

3) The storm door of claim 1, wherein a thickness of the storm door is greater than a thickness of an ordinary storm door.

4) The storm door of claim 3, wherein the thickness of the storm door is equal to about ½ inches.

5) The storm door of claim 4, wherein a thickness of the one or more insulated glass panels is equal to about ½ inches.

6) The storm door of claim 1, wherein the main portion is configured to secure one or more screen panels therein, wherein the one or more insulated glass panels may be replaced by the one or more screen panels.

7) The storm door of claim 1, wherein the recesses are each a rabbet.

8) The storm door of claim 1, wherein the storm door further comprises a flush-mount rim lock installed thereto.

9) The storm door of claim 1, wherein the storm door is sized for use with a standard doorway of a building.

10) The storm door of claim 9, wherein a width of the storm door is equal to about 3 feet, and wherein a height of the storm door is equal to about 6 feet 8 inches.

11) A storm door, comprising:
a main portion and a plurality of edge portions, wherein the plurality of edge portions consists of a top edge, a latch edge, and a hinge edge;
wherein the main portion is configured to secure one or more insulated glass panels therein;
wherein each edge portion of the plurality of edge portions comprises a recess in an interior-facing side of the storm door, wherein the recesses are each configured to receive an insulated gasket therein.

12) The storm door of claim 11, wherein a thickness of the storm door is greater than a thickness of an ordinary storm door.

13) The storm door of claim 12, wherein the main portion is configured to secure one or more screen panels therein, wherein the one or more insulated glass panels may be replaced by the one or more screen panels.

14) The storm door of claim 13, wherein the storm door is sized for use with a standard doorway of a building.
